(19) United States
(12) Patent Application Publication
(10) Pub. No.: US 2025/0347013 A1
(43) Pub. Date: Nov. 13, 2025

(54) METHOD FOR CATALYTICALLY SPLITTING WATER

(71) Applicant: KING FAHD UNIVERSITY OF PETROLEUM AND MINERALS, Dhahran (SA)

(72) Inventors: Abuzar KHAN, Dhahran (SA); Mohd Yusuf KHAN, Dhahran (SA)

(73) Assignee: KING FAHD UNIVERSITY OF PETROLEUM AND MINERALS, Dhahran (SA)

(21) Appl. No.: 19/276,068

(22) Filed: Jul. 22, 2025

Related U.S. Application Data
(62) Division of application No. 17/843,385, filed on Jun. 17, 2022.

(51) Int. Cl. C25B 11/095; C25B 1/04; C25B 1/55; C25B 9/50; C25B 11/052; C25B 11/067

(52) U.S. Cl. CPC C25B 11/095; C25B 1/04; C25B 1/55; C25B 9/50; C25B 11/052; C25B 11/067

(57) ABSTRACT

A photoelectrode includes a fluorine-doped tin oxide (FTO) substrate, and a layer of graphitic-poly(2,4,6-triaminopyrimidine) (g-PTAP) nanoflakes at least partially covering a surface of the FTO substrate. Further, the g-PTAP nanoflakes have a width of 0.1 to 5 micrometers (μm). In addition, a method for producing the photoelectrode, and a method for photocatalytic water splitting, in which the photoelectrode is used.

### BACKGROUND

### Technical Field

The present disclosure is directed to a photoelectrode, particularly to a photoelectrode having a layer of graphitic-poly (2,4,6-triaminopyrimidine) (g-PTAP) and a method of photocatalytic water splitting using the electrode.

### Description of Related Art

The “background” description provided herein is for the purpose of generally presenting the context of the disclosure. Work of the presently named inventors, to the extent it is described in this background section, and aspects of the description that may not otherwise qualify as prior art at the time of filing, are neither expressly or impliedly admitted as prior art against the present invention.

Various technologies such as a photovoltaic cell, a photo-electrochemical cell (PEC), and solar collectors are used with varying converting efficiencies. Conventionally, inorganic semiconductor materials are used as photocatalysts for water splitting. However, inorganic semiconductor materials have many drawbacks: toxicity, expensiveness, low stability, intrinsic deficiency of band positions, and little exploitation of visible light. Hence, the inorganic semiconductor materials are not suitable for large-scale sustainable development. In recent years, metal-free photocatalysts like graphitic nitride, polythiophene, poly(phenylenevinylene), polyimide, and corresponding derivates have been explored as potential photocatalyst for water splitting reactions. Graphitic nitride (g-C₃N₄) was used as a photocatalyst for its thermal and chemical stability and easy fabrication with inexpensive nitrogen-containing carbon-based precursors by the thermal polycondensation process. However, g-C₃N₄ has low crystallinity and a high degree of disorder, which decreases its photoactivity. Moreover, a relatively large band gap (2.7 eV) of g-C₃N₄ limits visible light absorption. Hence, there is a need for methods to reduce or eliminate the limitations above.

### SUMMARY

In an exemplary embodiment, a photoelectrode is described. The photoelectrode includes a fluorine-doped tin oxide (FTO) substrate and a layer of graphitic-poly (2,4,6-triaminopyrimidine) (g-PTAP) nanoflakes at least partially covering a surface of the FTO substrate.

In some embodiments, the layer of g-PTAP nanoflakes has a sheet like morphology.

In some embodiments, the g-PTAP nanoflakes have an average thickness of 5 to 100 nanometer (nm).

In some embodiments, the g-PTAP nanoflakes have an average length of 0.2 to 10.0 micrometers (μm).

In some embodiments, the g-PTAP nanoflakes have an average width of 0.1 to 5.0 μm.

In some embodiments, the g-PTAP nanoflakes have a width in a range of 0.5 to 1.5 μm.

In some embodiments, the layer of g-PTAP nanoflakes has a pore size in a range of 1 to 1000 nm.

In some embodiments, the g-PTAP nanoflakes have an interlayer stacking of repeated triazine units.

In some embodiments, the g-PTAP nanoflakes are arranged in an aggregated lamellae form and are slackly packed.

In some embodiments, the g-PTAP nanoflakes have a maximum light absorbance in a visible range.

In some embodiments, the photoelectrode has a band gap at 1.2 to 2.5 electron volts (eV).

In some embodiments, the photoelectrode has a band gap at 1.5 to 2.0 eV.

In some embodiments, the g-PTAP nanoflakes have a broad and intense peak in a range of 2 theta (θ) value 25 to 30° in an X-ray diffraction (XRD) spectrum.

In some embodiments, the g-PTAP nanoflakes have a first main peak in a range of 280 to 290 eV in an X-ray photoelectron spectroscopy (XPS) spectrum, and a second main peak in a range of 394 to 398 eV in the XPS.

In some embodiments, the g-PTAP nanoflakes have peaks at 1250 to 1600 centimeter inverse (cm⁻¹) and 3100 to 3500 cm⁻¹ in a Fourier transform infrared spectrum (FT-IR).

In some embodiments, the g-PTAP nanoflakes have peaks at 1500 to 1590 cm⁻¹ and 3300 to 3450 cm⁻¹ in the FT-IR.

In some embodiments, a method for producing the photoelectrode includes thermal vapor condensation polymerizing (TVCP) 2,4,6-triaminopyrimidine (TAP) onto the FTO substrate at a temperature in a range of 250 to 500 degrees Celsius (° C.) to form a poly (2,4,6-triaminopyrimidine) (PTAP) and a layer of PTAP at least partially covering the surface of FTO substrate.

In some embodiments, the TVCP further heating the poly (2,4,6-triaminopyrimidine) (PTAP) and the FTO substrate with the PTAP layer on the surface at a temperature in a range of 250 to 800° C. to form graphitic-poly (2,4,6-triaminopyrimidine) (g-PTAP) nanoflakes and the layer of g-PTAP nanoflakes at least partially covering the surface of FTO substrate.

In some embodiments, the 2,4,6-triaminopyrimidine and the FTO substrate are heated in a range of 300 to 500° C.

In another exemplary embodiment, a method of photocatalytic water splitting is described. The method includes irradiating a photoelectrochemical cell including the g-PTAP photoelectrode and water with sunlight to form hydrogen and oxygen.

In some embodiments, the photoelectrochemical cell includes a counter electrode, a reference electrode, a working electrode, and an electrolyte present between the counter electrode, the reference electrode, and the working electrode.

In some embodiments, the method of photocatalytic water splitting has a repeatability of at least 99%.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an experimental setup for the fabrication of graphitic-poly (2,4,6-triaminopyrimidine) (g-PTAP) photoelectrode, according to certain embodiments;

FIG. 1B is a schematic representation showing a thermal vapor polymerization mechanism of the g-PTAP, according to certain embodiments;

FIG. 2A is a field emission scanning electron microscope (FE-SEM) of the g-PTAP at low resolution, according to certain embodiments;

FIG. 2B is the FE-SEM of the g-PTAP at higher resolution and Energy-dispersive X-ray spectroscopy (EDS) of the g-PTAP, according to certain embodiments;

FIG. 3A is a graph depicting Fourier transform infrared spectrum (FT-IR) of triaminopyrimidine (TAP) and the g-PTAP, according to certain embodiments;

FIG. 3B is a graph depicting Raman spectrum of the g-PTAP, according to certain embodiments;

FIG. 3C is a graph depicting X-ray diffraction (XRD) spectrum of the g-PTAP on a fluorine-doped tin oxide (FTO) substrate, according to certain embodiments;

FIG. 3D is a graph depicting the XRD spectrum of the g-PTAP powder, according to certain embodiments;

FIG. 4A is a graph depicting an X-ray photoelectron spectroscopy (XPS) spectrum of the g-PTAP, including C1s, N1s, and Ols spectra, according to certain embodiments;

FIG. 4B is a graph depicting the C1s spectrum of the g-PTAP, according to certain embodiments;

FIG. 4C is a graph depicting the N1s spectrum of the g-PTAP, according to certain embodiments;

FIG. 5A is a graph depicting ultraviolet-visible spectroscopy (UV-Vis) diffuse reflectance spectroscopy (DRS) of the g-PTAP, according to certain embodiments;

FIG. 5B is a Tauc plot of the g-PTAP, according to certain embodiments;

FIG. 6A is a graph depicting chronoamperometric I-t curves with 30 seconds(s) ON/OFF cycle collected at 1 volt (V) vs. saturated calomel electrode (SCE), according to certain embodiments;

FIG. 6B is a graph depicting chronoamperometric I-t curves with 30 seconds(s) ON/OFF cycle collected at −0.2 V vs. SCE, according to certain embodiments;

FIG. 6C is a graph depicting I-t stability curves under illumination, according to certain embodiments; and

FIG. 6D is a graph showing electronic impedance spectroscopy (EIS) Nyquist plot spectra under dark and light, according to certain embodiments.

### DETAILED DESCRIPTION

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

As used herein, the term “nano-sheets” refers to a two-dimensional nanostructure with a thickness on a scale ranging from 1 to 1,000 nm.

As used herein, the term “nanoflakes” refers to a plate-like form or structure with at least one nanometric dimension.

As used herein, the term “length” refers to the longest measurement of a shape (e.g., nanoflake) from side to side.

As used herein, the term “width” refers to the longest measurement of a shorter side of a shape (e.g., nanoflake), that is perpendicularly to the longest dimension from side to side,

As used herein, the term “graphitic” refers to a material having a physical structure similar to the overlapping sheets in graphite, e.g., where carbon atoms are strongly bonded together in sheets.

As used herein, the term “substrate” refers to a single or multi-dimensional, natural or synthetic material or substance capable of supporting two-dimensional monolayer assemblies.

As used herein, the term “OER” (oxygen evolution reaction) refers to a process of generating molecular oxygen through chemical reaction, such as electrolysis of water into oxygen.

As used herein, the term “HER” (hydrogen evolution reaction) refers to a process of generating molecular hydrogen through chemical reaction, such as electrolysis of water into hydrogen.

Aspects of the present disclosure are directed towards an electrode of graphitic (2,4,6-triaminopyrimidine), which may be represented as for example g-C₃N₄, which has high carbon content as compared to melamine, and a shorter band gap fabricated on a fluorine-doped tin oxide (FTO) substrate. The graphitic-poly (2,4,6-triaminopyrimidine) (g-PTAP) is preferably synthesized by thermal vapor condensation polymerization (TVCP) onto FTO glass (although other substrates may be used-see infra). The structure, morphology, and optical characteristics of the resultant g-PTAP were analyzed using analytical techniques such as Fourier-transform infrared spectroscopy (FT-IR), Raman spectroscopy, X-ray diffraction (XRD), X-ray photoelectron spectroscopy (XPS), the wt. % of carbon, hydrogen and nitrogen analysis (CHNS), field emission scanning electron microscopes (FE-SEM), energy-dispersive spectroscopy (EDS), and differential reflectance spectroscopy (DRS). The synthesized g-PTAP was graphitic with sheet-like morphology and revealed maximum light absorbance capacity in the visible range. The electrode was further evaluated for photocatalytic water splitting performance. The results indicate that the g-PTAP sample exhibited good photo-stability as a photocathode compared to a photoanode. The present disclosure provides the photoelectrode, which is non-toxic and inexpensive, circumventing the prior art's drawbacks.

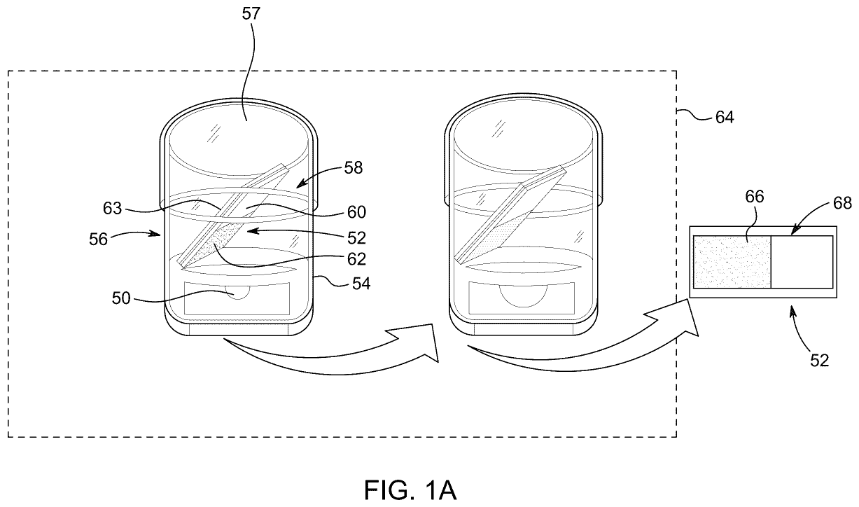

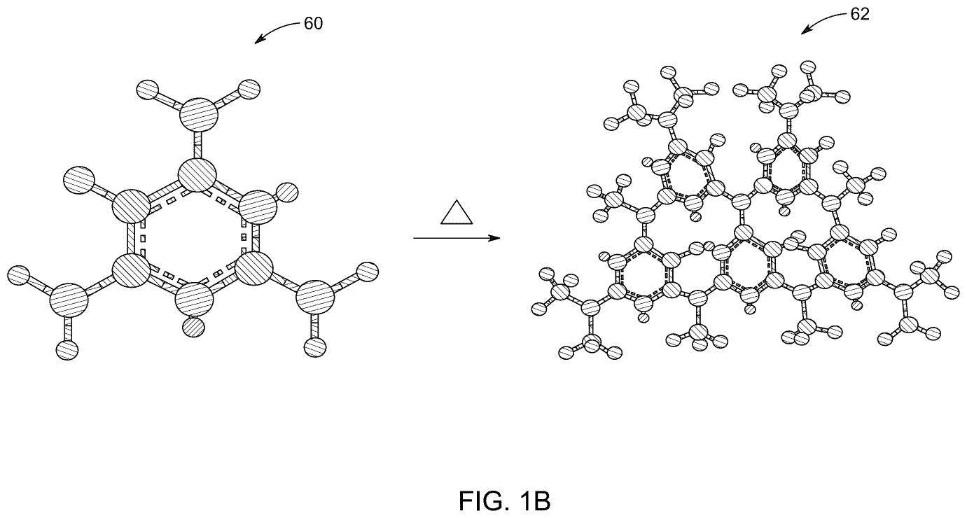

The photoelectrode includes a layer of g-PTAP nanoflakes at least partially covering a surface of a fluorine-doped tin oxide (FTO) substrate. In some embodiments, the photoelectrode may include, but is not limited to, graphitic nitride, polythiophene, poly(phenylenevinylene), polyimide, and related derivates. In some embodiments, the layer of g-PTAP nanoflakes may be present on silicon. In some embodiments, the layer of g-PTAP nanoflakes may be present on indium tin oxide (ITO). In some embodiments, the layer of g-PTAP nanoflakes may be present on aluminum-doped zinc oxide. In some embodiments, the g-PTAP nanoflakes covers at least 1% of the surface of the substrate. In some embodiments, the g-PTAP nanoflakes covers at least 15% of the surface of the substrate. In another embodiment, the g-PTAP nanoflakes covers at least 45% of the surface of the substrate. In a preferred embodiment, the g-PTAP nanoflakes covers at least 75% of the surface of the substrate. In a further preferred embodiment, the g-PTAP nanoflakes covers at least 95% of the surface of the substrate. In a more preferred embodiment, the g-PTAP nanoflakes covers at least 99% of the surface of the substrate. In some embodiments, the g-PTAP nanoflakes covers less than or equal to 99% of the surface of the substrate. In some embodiments, the g-PTAP nanoflakes covers less than or equal to 99% of the surface of the substrate. In another embodiment, the g-PTAP nanoflakes covers less than or equal to 75% of the surface of the substrate. In a preferred embodiment, the g-PTAP nanoflakes covers less than or equal to 45% of the surface of the substrate. In a further preferred embodiment, the g-PTAP nanoflakes covers less than or equal to 15% of the surface of the substrate. In a more preferred embodiment, the g-PTAP nanoflakes covers less than or equal to 1% of the surface of the substrate. In one embodiment, the layer of g-PTAP nanoflakes covers the substrate in a continuous fashion from a first edge of the substrate to a second edge of the substate. In another embodiment, the layer of g-PTAP nanoflakes covers the substrate in a discontinuous fashion, e.g., covering a first surface of the substrate (52) with a metallic foil (60) as depicted in FIG. 1A, removing the metallic foil after TVCP to afford the layer of g-PTAP nanoflakes covering from the first edge of the substrate to a middle position of the substrate, where the middle position is at a first edge of the metallic foil before removal.

In some embodiments, the layer of g-PTAP nanoflakes has an average pore size in a range of 1 to 1000 nm. In some embodiments, the layer of g-PTAP nanoflakes has an average pore size in a range of 20 to 800 nm. In another embodiment, the layer of g-PTAP nanoflakes has an average pore size in a range of 50 to 500 nm. In a further preferred embodiment, the layer of g-PTAP nanoflakes has an average pore size in a range of 100 to 300 nm. In a more preferred embodiment, the layer of g-PTAP nanoflakes has an average pore size in a range of 150 to 180 nm. In some embodiments, the g-PTAP nanoflakes have an interlayer stacking of repeated triazine units. In some embodiments, an upper surface of the g-PTAP nanoflakes may also be covered by the triazine units.

In some embodiments, the g-PTAP nanoflakes have an average thickness in a range of 5 to 100 nm. In some embodiments, the g-PTAP nanoflakes have an average thickness in a range of 10 to 80 nm. In some embodiments, the g-PTAP nanoflakes have an average thickness in a range of 15 to 60 nm. In certain embodiments, the g-PTAP nanoflakes have an average thickness in a range of 15 to 40 nm. In some embodiments, the g-PTAP nanoflakes have an average length in a range of 0.2 to 10 μm. In some embodiments, the g-PTAP nanoflakes have an average length in a range of 0.4 to 8 μm. In some embodiments, the g-PTAP nanoflakes have an average length in a range of 0.8 to 6 μm. In certain embodiments, the g-PTAP nanoflakes have an average length in a range of 0.8 to 4 μm. In some embodiments, the g-PTAP nanoflakes have an average width in a range of 0.1 to 5 μm. In some embodiments, the g-PTAP nanoflakes have an average width in a range of 0.2 to 4 μm. In some embodiments, the g-PTAP nanoflakes have an average width in a range of 0.3 to 3 μm. In certain embodiments, the g-PTAP nanoflakes have an average width in a range of 0.4 to 2 μm.

In some embodiments, the g-PTAP nanoflakes are arranged in an aggregated lamellae form having a non-porous surface. In some embodiments, the g-PTAP nanoflakes are arranged in aggregated spherical, cylindrical, and vesicle forms. The g-PTAP nanoflakes are slackly packed to form the layer of g-PTAP. In some embodiments, the layer of g-PTAP nanoflakes has a sheet-like morphology. In some embodiments, a distance of the g-PTAP layers is in a range of 1 to 500 nm, 5 to 250 nm, preferably 10 to 100 nm, further preferably 15 to 80 nm, more preferably 20 to 40 nm. In some embodiments, a length of the g-PTAP layers is in a range of 0.1 to 20 μm, preferably 0.2 to 10 μm, further preferably 0.4 to 5 μm, more preferably 0.8 to 4 μm. In some embodiments, a width of the g-PTAP layers is in a range of 0.1 to 10 μm, preferably 0.2 to 8 μm, further preferably 0.4 to 6 μm, more preferably 0.8 to 4 μm. Other ranges are also possible.

In some embodiments, the g-PTAP nanoflakes have a maximum light absorbance in a visible range. In some embodiments, the g-PTAP nanoflakes have an efficient light absorbance in the ultra-visible range. In some embodiments, the g-PTAP electrode has a band gap at 1.0 to 4.0 electron volts (eV). In another embodiment, the g-PTAP electrode has a band gap at 1.1 to 3.0 eV. In some embodiments, the g-PTAP electrode has a band gap at 1.2 to 2.5 eV. In a further preferred embodiment, the g-PTAP electrode has a band gap at 1.5 to 2.0 eV. In a more preferred embodiment, the g-PTAP electrode has a band gap at 1.6 to 1.9 eV.

In some embodiments, the g-PTAP nanoflakes have at least one broad and intense peak with a 2 theta (θ) value in a range of 20 to 55° in an X-ray diffraction (XRD) spectrum. In some embodiments, the g-PTAP nanoflakes have at least one broad and intense peak with 20 value in a range of 25 to 45° in the XRD spectrum. In another embodiment, the g-PTAP nanoflakes have at least one broad and intense peak with 2θ value in a range of 25 to 35° in the XRD spectrum. In a further preferred embodiment, the g-PTAP nanoflakes have at least one broad and intense peak with 20 value in a range of 25 to 30° in the XRD spectrum. In a more preferred embodiment, the g-PTAP nanoflakes have at least one broad and intense peak with 20 values in a range of 27 to 29° in the XRD spectrum. In some embodiments, the photoelectrode has a first main peak in a range of 275 to 295 eV, and a second main peak in a range of 385 to 405 eV in an X-ray photoelectron spectroscopy (XPS) spectrum. In some embodiments, the photoelectrode has a first main peak in a range of 280 to 290 eV, and a second main peak in a range of 390 to 400 eV in the XPS. In a further preferred embodiment, the photoelectrode has a first main peak in a range of 282 to 288 eV, and a second main peak in a range of 392 to 398 eV in the XPS. In a more preferred embodiment, the photoelectrode has a first main peak in a range of 283 to 287 eV, and a second main peak in a range of 395 to 398 eV in the XPS. In some embodiments, the g-PTAP nanoflakes have peaks at 1100 to 1700 cm⁻¹, and 2900 to 3600 cm⁻¹ in a Fourier transform infrared spectrum (FT-IR). In some embodiments, the g-PTAP nanoflakes have peaks at 1200 to 1650 cm⁻¹, and 3000 to 3550 cm⁻¹ in the FT-IR. In another embodiment, the g-PTAP nanoflakes have peaks at 1250 to 1600 cm⁻¹, and 3100 to 3500 cm⁻¹ in the FT-IR. In a further preferred embodiment, the g-PTAP nanoflakes have has peaks at 1350 to 1600 cm⁻¹, and 3200 to 3450 cm⁻¹ in the FT-IR. In a more preferred embodiment, the g-PTAP nanoflakes have has peaks at 15000 to 1590 cm⁻¹, and 3300 to 3450 cm⁻¹ in the FT-IR. In some embodiments, the g-PTAP nanoflakes have peaks at 1000 to 1800 cm⁻¹ in a Raman spectrum. In some embodiments, the g-PTAP nanoflakes have peaks at 1100 to 1700 cm⁻¹ in the Raman spectrum. In another embodiment, the g-PTAP nanoflakes have peaks at 1200 to 1600 cm⁻¹ in the Raman spectrum. In a further preferred embodiment, the g-PTAP nanoflakes have peaks at 1300 to 1580 cm⁻¹ in the Raman spectrum. In a more preferred embodiment, the g-PTAP nanoflakes have peaks at 1350 to 1560 cm⁻¹ in the Raman spectrum

Referring to FIG. 1A, a method for the fabrication of graphitic poly (2,4,6-triaminopyrimidine) (g-PTAP) photoelectrode is illustrated. The method including experimental setup described is to read in conjunction with a schematic representation showing a thermal vapor polymerization mechanism of the g-PTAP as illustrated in FIG. 1B. The order in which the method is described is not intended to be construed as a limitation, and any number of the described method steps may be combined in any order to implement the method. Additionally, individual steps may be removed or skipped from the method without departing from the spirit and scope of the present disclosure. In some embodiments, the method includes adding a 2,4,6-triaminopyrimidine (TAP) (50) to a ceramic disc (54) and placing the disc in a cylindrical glass tube (56). The glass tube (56) includes a glass lid (57). In some embodiments, one or more suitable pyrimidine derivatives may be present in an amount effective to produce the photoelectrode in the method stated above. For non-limiting examples, the pyrimidine derivative may be 2,4-diamino-6-hydroxypyrimidine, 2-amino-4,6-dihydroxypyrimidine, 4-amino-2,6-dihydroxypyrimidine, melamine, 1,3,5-triaminobenzene, other diamine substituted-triazines, other diamine substituted-heptazines, other triamine substituted-triazines, other triamine substituted-heptazines, and their salt forms.

The term “amine substituted compounds” includes aliphatic, cyclic, aromatic, non-aromatic, carbocyclic, heterocyclic, aromatic carbocyclic, non-aromatic carbocyclic, aromatic heterocyclic, or non-aromatic heterocyclic hydrocarbons that are substituted with (a) at least one functional group of formula —NRₐR_{b}, or (b) at least one moiety having at least one functional group of formula —NRₐR_{b}, wherein Rₐ and R_{b} are each independently hydrogen, alkyl, aryl, heterocyclyl, or any other substituent. Non-limiting examples of amines include aminobenzene, 3-amino-1,2,4-triazole, 5-amino-1,2,4-triazole, 4-amino-1,2,3-triazole, 5-amino-1,2,3-triazole, 5-aminotetrazole, 2-amino-1,3,5-triazine, 3-amino-1,2,4-triazine, 5-amino-1,2,4-triazine, 6-amino-1,2,4-triazine, and like.

The term “diamine substituted compounds” includes aliphatic, cyclic, aromatic, non-aromatic, carbocyclic, heterocyclic, aromatic carbocyclic, non-aromatic carbocyclic, aromatic heterocyclic, or non-aromatic heterocyclic hydrocarbons that are substituted with (a) two functional groups of formula —NRₐR_{b}, (b) a moiety having two functional groups of formula —NRₐR_{b}, or (c) two same or different moieties, each substituted with a functional group of formula —NRₐR_{b}, wherein Rₐ and R_{b} are each independently hydrogen, alkyl, aryl, heterocyclyl, or any other substituent. Non-limiting examples of di-amines include p-Phenylenediamine, o-Phenylenediamine, m-Phenylenediamine, Dimethyl-4-phenylenediamine, N,N,N′,N′-tetramethyl-p-phenylenediamine, N,N-diethyl-p-phenylenediamine, 4-N,4-N-diethyl-2-methylbenzene-1,4-diamine, 3,5-diamino-1,2,4-triazole, 4,5-diamino-1,2,3-triazole, and the like.

The term “triamine substituted compounds” includes aliphatic, cyclic, aromatic, non-aromatic, carbocyclic, heterocyclic, aromatic carbocyclic, non-aromatic carbocyclic, aromatic heterocyclic, or non-aromatic heterocyclic hydrocarbons that are substituted with (a) three functional groups of formula —NRₐR_{b}, (b) a moiety having three functional groups of formula —NRₐR_{b}, or (c) three same or different moieties, each substituted with a functional group of formula —NRₐR_{b}, wherein Rₐ and R_{b} are each independently hydrogen, alkyl, aryl, heterocyclyl, or any other substituent. Non-limiting examples of tri-amines include benzene-1,2,3-triamine, benzene-1,2,4-triamine, benzene-1,3,5-triamine, 2,4,6-triamino-1,3,5-triazine, 3,5,6-triamino-1,2,4-triazine, and the like.

In some embodiments, one or more suitable compound of formula I as defined below may be present in an amount effective to produce a graphitic carbon nitride photoelectrode.

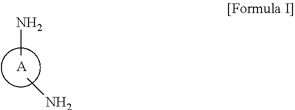

where the ring A represents a 5- or 6-membered carbocyclic ring or a 5- or 6-membered heterocyclic ring. In a non-limiting example, the 5- or 6-membered heterocyclic ring may be selected from a group consisting of a pyrrolidine derivative, a pyrroline derivative, a pyrrole derivative, a piperidine derivative, or a pyridine derivative, a pyrazolidine derivative, a pyrazoline derivative, a pyrazole derivative, a pyridazine derivative. Further, it is contemplated that one or more N hetero atoms in formula I may be replaced by any other suitable heteroatom, for example, but not limited to, O, and S.

In certain embodiments, one or more suitable compound of formula II as defined below may be present in an amount effective to produce the graphitic carbon nitride photoelectrode.

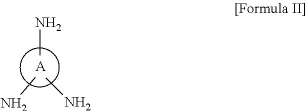

where: the ring A represents a 5- or 6-membered carbocyclic ring or a 5- or 6-membered heterocyclic ring. In a non-limiting example, the 5- or 6-membered heterocyclic ring may be selected from a group consisting of a pyrrolidine derivative, a pyrroline derivative, a pyrrole derivative, a piperidine derivative, or a pyridine derivative, a pyrazolidine derivative, a pyrazoline derivative, a pyrazole derivative, a pyridazine derivative. Further, it is contemplated that one or more N hetero atoms in formula I may be replaced by any other suitable heteroatom, for example, but not limited to, O, and S.

In certain embodiments, a fluorine-doped tin oxide (FTO) substrate (52) with at least a first edge end and a second edge is used to fabricate the photoelectrode in the method stated above. In one aspect, the FTO glass has a surface resistivity of at least 1 Ω/sq, at least 10 Ω/sq, at least 50 Ω/sq, or at least 100 Ω/sq. In another embodiments, the FTO glass has a surface resistivity of less than or equal to 200 Ω/sq, less than or equal to 100 Ω/sq, less than or equal to 50 Ω/s, or less than or equal to 10 Ω/s. In some embodiments, the first edge of the FTO glass (52) is placed against a wall of the cylindrical glass tube (56) as depicted in FIG. 1A, and the second edge of said FTO glass (52) is placed on an edge of the ceramic disc (54) as depicted in FIG. 1A. The FTO glass (52) is at least partially covered by a metallic foil (60) on a first surface (58). A second surface (62) of the FTO glass (52) is left uncovered. In some embodiments, the metallic foil is made from a group consisting of platinum, aluminum, nickel, tin, copper, and zinc. In an embodiment, the second substrate is an aluminum foil. The FTO glass (52) was placed such that a non-conducting surface (63) faced an outer wall of the glass tube (56) as depicted in FIG. 1A. The cylindrical glass tube (56) covered with the glass lid (57) is placed in a furnace (64).

In some embodiments, the method for producing the photoelectrode includes heating the 2,4,6-triaminopyrimidine (TAP) (50) and the FTO (52) substrate to form a layer of PTAP on the FTO substrate. In some embodiments, the TAP and the FTO substrate are heated in a furnace in a range of 250 to 500° C., 270 to 450° C., preferably 290 to 400° C., more preferably 310 to 350° C., and even more preferably 320 to 330° C. for at least 5 minutes, at least 15 minutes, at least 60 minutes, at least 180 minutes, or at least 360 minutes. In some embodiments, the TAP and the FTO substrate are heated in a furnace in a range of 250 to 500° C., 270 to 450° C., preferably 290 to 400° C., more preferably 310 to 350° C., and even more preferably 320 to 330° C. for less than or equal to 600 minutes, less than or equal to 300 minutes, less than or equal to 150 minutes, less than or equal to 60 minutes, or less than or equal to 15 minutes. Other ranges are also possible.

In some embodiments, the method for producing the photoelectrode further includes heating the PTAP and the layer of PTAP on the FTO substrate to from a g-PTAP. In some embodiments, the PTAP and the layer of PTAP on the FTO substrate are further heated in a furnace in a range of 250 to 800° C., 300 to 700° C., preferably 350 to 600° C., more preferably 400 to 500° C., and even more preferably 430 to 470° C. for at least 60 minutes, at least 120 minutes, at least 240 minutes, at least 360 minutes, or at least 480 minutes. In some embodiments, the TAP and the FTO substrate are heated in a furnace in a range of 250 to 800° C., 300 to 700° C., preferably 350 to 600° C., more preferably 400 to 500° C., and even more preferably 430 to 470° C. for less than or equal to 1000 minutes, less than or equal to 800 minutes, less than or equal to 600 minutes, less than or equal to 400 minutes, or less than or equal to 200 minutes. Other ranges are also possible.

In an embodiment, a method of photocatalytic water splitting reaction is disclosed. The method includes irradiating a photoelectrochemical cell including the g-PTAP electrode and water with sunlight to form hydrogen and oxygen. The disclosed photoelectrochemical cell comprises: a working electrode comprising the g-PTAB electrode, a counter electrode comprising a platinum (Pt) electrode, a reference electrode comprising a saturated calomel electrode (SCE), an electrolyte and a solar simulator fitted with a UV cut-off filter. In certain embodiments, the UV cut-off filter has a bandpass wavelength λ greater than or equal to 420 nm, greater than or equal to 450 nm, greater than or equal to 510 nm, or greater than or equal to 580 nm. Other ranges are also possible.

In some embodiments, the working electrode is selected from the group consisting of poly (2,4,6-triaminopyrimidine) fabricated indium tin oxide, poly (2,4,6-triaminopyrimidine) fabricated fluorine-doped tin oxide (FTO), and poly (2,4,6-triaminopyrimidine) fabricated aluminum-doped zinc oxide. In a preferred embodiment, the working electrode is the g-PTAB electrode. In some embodiments, the counter electrode is a metallic foil. In some embodiments, the metallic foil is made from a group consisting of platinum, aluminum, nickel, tin, copper, and zinc. In an embodiment, the counter electrode is a platinum foil. In one embodiment, the g-PTAP electrode in the photoelectrochemical cell may work as a photocathode. In another embodiment, the g-PTAP electrode in the photoelectrochemical cell may work as a photoanode.

In some embodiments, the electrolyte is selected from the group consisting of an alkali metal hydroxide, an alkaline earth hydroxide, an alkali metal salt, and an alkaline earth salt. In a preferred embodiment, the electrolyte is potassium hydroxide. In some embodiments, the electrolyte is dissolved in water and has a molarity of 0.01-10 M, preferably 0.1-5 M, or 0.5-1M.

The disclosed method of photocatalytic water splitting reaction may achieve a photocurrent. In some embodiments, the photocurrent obtained in the disclosed method is at a potential from about −0.5 to 2 V vs SCE, preferably from about −0.4 to 1.6 V, more preferably from about −0.3 to 1.2 V, and even more preferably from about −0.2 to 1.0 V. Other ranges are also possible. In some embodiments, the photocurrent obtained in the disclosed method is under alternating light and dark cycles of between 0 to 300 s interval, preferably between 10 to 150 s interval, more preferably between 20 to 70 s interval, and even more preferably between 25 to 35 s interval. Other ranges are also possible. In certain embodiments, a stability of g-PTAP electrode is determined by measuring a photocurrent vs time response under illumination, wherein the measured photocurrent has less than or equal to 20% change compared to an initial measurement, preferably less than or equal to 15% change, more preferably less than or equal to 10% change, and even more preferably less than or equal to 5% change.

In some embodiments, the photocurrent obtained in the disclosed method, wherein the g-PTAP electrode in the photoelectrochemical cell works as the photocathode, is in a range of 0.1 to 10.0 μAcm⁻². In some embodiments, the photocurrent is in a range of 0.2 to 9.0 μAcm⁻². In one embodiment, the photocurrent is in a range of 0.3 to 8.0 μAcm⁻². In a further preferred embodiment, the photocurrent is in a range of 0.4 to 7.0 μAcm⁻². In a more preferred embodiment, the photocurrent is in a range of 0.5 to 6.0 μAcm⁻². In an even more preferred embodiment, the photocurrent is in a range of 0.6 to 2.5 μAcm⁻².

In some embodiments, the photocurrent obtained in the disclosed method, wherein the g-PTAP electrode in the photoelectrochemical cell works as the photoanode, is in a range of −10.0 to −0.1 μAcm⁻². In some embodiments, the photocurrent is in a range of −9.0 to −0.2 μAcm⁻². In one embodiment, the photocurrent is in a range of −8.0 to −0.3 μAcm⁻². In a further preferred embodiment, the photocurrent is in a range of −7.0 to −0.4 μAcm⁻². In a more preferred embodiment, the photocurrent is in a range of −6.0 to −0.5 μAcm⁻². In an even more preferred embodiment, the photocurrent is in a range of −5.0 to 1.0 μAcm⁻².

In certain embodiments, the stability of the photocurrent obtained in the disclosed method, wherein the g-PTAP electrode in the photoelectrochemical cell works as the photocathode, is in a range of 10 to 300 minutes, preferably in a range of 30 to 200 minutes, more preferably in a range of 60 to 150 minutes, and even more preferably in a range of 90 to 120 minutes. Other ranges are also possible.

In certain embodiments, the stability of the photocurrent obtained in the disclosed method, wherein the g-PTAP electrode in the photoelectrochemical cell works as the photoanode, is in a range of 5 to 200 minutes, preferably in a range of 10 to 100 minutes, more preferably in a range of 20 to 70 minutes, and even more preferably in a range of 30 to 50 minutes. Other ranges are also possible.

In some embodiments, the g-PTAP electrode in the disclosed method has an interfacial charge transfer resistance under illumination in a range of 0 to 4.0×10⁵Ω, preferably in a range of 1×10⁵ to 3.5×10⁵Ω, more preferably in a range of 2.0×10⁵ to 3.0×10⁵Ω, and even more preferably in a range of 2.5×10⁵ to 2.8×10⁵Ω. Other ranges are also possible. In certain embodiments, the g-PTAP electrode in the disclosed method has an interfacial charge transfer resistance under dark conditions in a range of 0 to 6.0×10⁵Ω, preferably in a range of 1.0×10⁵ to 5.0×10⁵Ω, more preferably in a range of 3.0×10⁵ to 4.8×10⁵Ω, and even more preferably in a range of 4×10⁵ to 4.5×10⁵Ω. Other ranges are also possible.

In some embodiments, the method of photocatalytic water splitting has a repeatability of at least 80%. In some embodiments, the method of photocatalytic water splitting has a repeatability of at least 85%. In another embodiment, the method of photocatalytic water splitting has a repeatability of at least 90%. In a further preferred embodiment, the method of photocatalytic water splitting has a repeatability of at least 95%. In a more preferred embodiment, the method of photocatalytic water splitting has a repeatability of at least 99%.

### EXAMPLES

The following examples describe and demonstrate exemplary embodiments of the electrode for photocatalytic water splitting described herein. The examples are provided solely for illustration and are not to be construed as limitations of the present disclosure, as many variations thereof are possible without departing from the spirit and scope of the present disclosure.

### Example 1. Fabrication of g-PTAP Photoelectrode

FIG. 1A shows an experimental setup for the fabrication of a g-PTAP photoelectrode. 2,4,6-triaminopyrimidine (TAP (50), 97% Sigma Aldrich) was used as a precursor to obtain graphitic poly (2,4,6-triaminopyrimidine) (g-PTAP) by a thermal vapor condensation polymerization (TVCP) method on an FTO glass (52) (surface resistivity ˜13-ohm square (Ω/sq); Sigma-Aldrich). In the desired synthesis, 0.5 gram (g) of the TAP (50) was taken in a ceramic disc (54) and placed in a cylindrical glass tube (56). The glass tube (56) includes a glass lid (57). FTO glass (52) (2×1 centimeter (cm)), supported on the edge of the ceramic disc (54) and against a wall of the glass tube (56), was used to fabricate the photoelectrode. A first surface (58) of 1×1 cm dimensions of the FTO glass (52) was covered using aluminum foil (60) and a second surface (62) of 1×1 cm dimensions was left exposed. The FTO glass (52) was placed such that a non-conducting surface (63) faced an outer wall of the glass tube (56). The temperature of a furnace (64) was ramped to 325° C. (5° C. min⁻¹) with a dwelling time of 15 minutes. The temperature was further raised to attain a final temperature of 450° C. with a dwelling time of 4 hours. After the present reaction, the furnace (64) was cooled to room temperature (RT), and a dark brown solid (66) was deposited onto a conducting surface (68) of the FTO and also in the ceramic disc (54). The remaining polymerized powder (g-PTAP) was also collected from the ceramic disc (54) for characterization. FIG. 1B shows a schematic representation showing a thermal vapor polymerization mechanism of the g-PTAP. In FIG. 1B, chemical structures 60 and 62 correspond to the PTAP and g-PTAP, respectively.

### Example 2. Characterization Methods

The g-PTAP/FTO electrode was subjected to structural and morphological characterizations using various analysis techniques. Fourier transform infrared spectroscopy-attenuated total reflectance (FT-IR-ATR) spectra of the electrode were obtained on Nicolet 6700 spectrometer (Thermo Scientific). Crystallinity was deduced from the XRD pattern obtained on a high-resolution Rigaku X-ray diffractometer using Cu K\acute{α} λ=0.15406 nm as a radiation source. A sample was scanned between 2θ=10°-60° at a scan rate of 0.05 degrees/minutes). Morphology, surface details, and constituent elemental composition of a film on the FTO substrate were acquired on a dual-beam LYRA 3 (Tescan) instrument field emission scanning electron microscope (FE-SEM) conducted at 20 kilovolts (kV) (acceleration voltage). An SEM instrument was fitted with an energy dispersion spectrometer (EDS) (Oxford Instruments) to detect an elemental proportion and verify the elemental distribution and illustrations. Optical properties of materials were examined by Ultraviolet-Visible-near-IR Spectroscopy (UV-Vis-NIR) diffuse reflectance spectroscopy (DRS), Cary 5000 UV-Vis-NIR-Agilent. Raman spectra were recorded in 350-2400 cm⁻¹ with an excitation wavelength of 633 nm on a LabRAM HR 800 spectrometer (Horiba Yvon) fitted with an Olympus BX41 microscope, a charge-coupled device (CCD) detector wavelength. The Raman spectrum was evaluated in backscattering geometry mode in the 150 and 1200 cm⁻¹ range at a resolution of 0.5 cm⁻¹. XPS spectra were collected using ESCALAB 250Xi (Thermo Scientific, UK instrument). The weight percentage of carbon, hydrogen, and nitrogen (CHN) was determined on a 2400 elemental analyzer (Perkin Elmer EA) operating under the CHN mode.

### Example 3. Evaluation of g-PTAP Electrode for Water Splitting

The electrode was assessed for water splitting performance in a three-electrode photoelectrochemical cell. An electrolyte solution (0.5 molars (M) Na₂SO₄) was prepared using sodium sulfate (Sigma-Aldrich, ≥99.0%). In de-ionized water (resistivity<18.2 megaohms (M (2)). A cell was equipped with a saturated calomel electrode (SCE), a working electrode, and a platinum (Pt) electrode. The fabricated electrode served as the working electrode, whereas the Pt and SCE electrodes served as counter and reference electrodes. The cell was connected to an Autolab potentiostat with NOVA 2.1.1 software. A simulated light was obtained from Oriel Sol-AAA (Newport) solar simulator calibrated with a silicon diode solar cell (Oriel-diode) fixed at 100 milliwatts per centimeter squared (mW/cm²) before photo electrocatalysis (PEC) experiments. Further, the solar simulator was fitted with AM-1.5G and UV cut-off (λ>420 nm) filters.

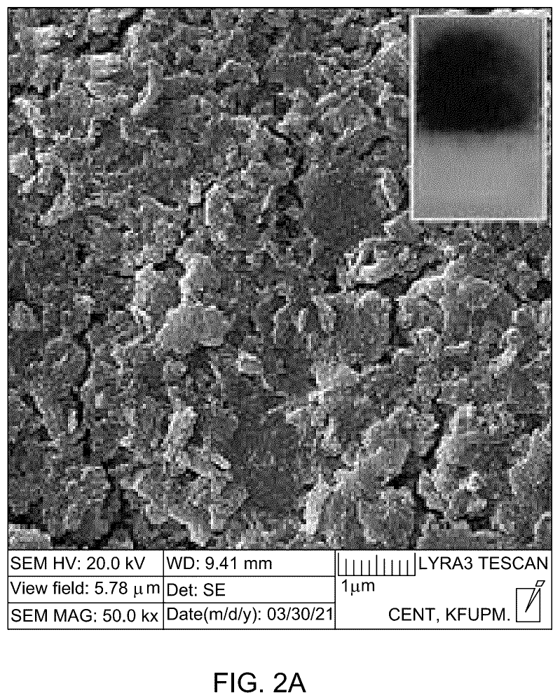

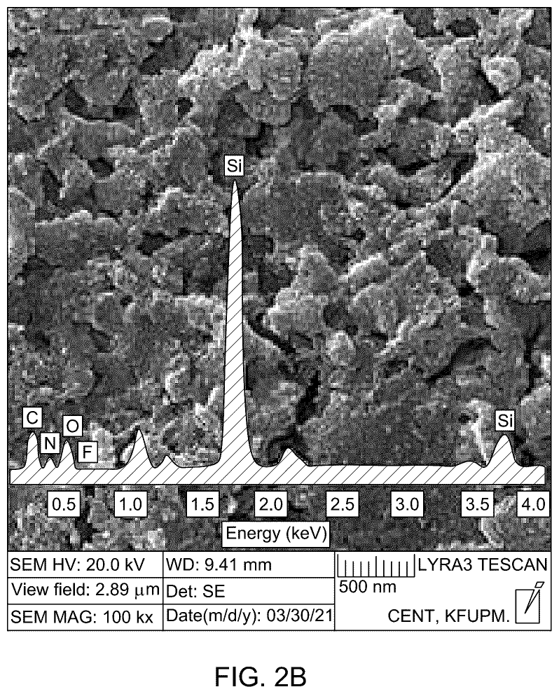

Microstructural morphology and elemental distribution of the g-PTAP were studied by the FE-SEM and EDS, respectively, as shown in the low and high-resolution FE-SEM micrographs (FIG. 2A and FIG. 2B, respectively). FIGS. 2A-2B shows that the g-PTAP includes two-dimensional (2D) irregular nanosheets arranged in aggregated lamellae form with a non-porous surface and are slackly packed. Moreover, an inset of FIG. 2B illustrates the EDS spectrum of the g-PTAP on the FTO substrate verifying the existence of nitrogen and carbon elements in the g-PTAP.

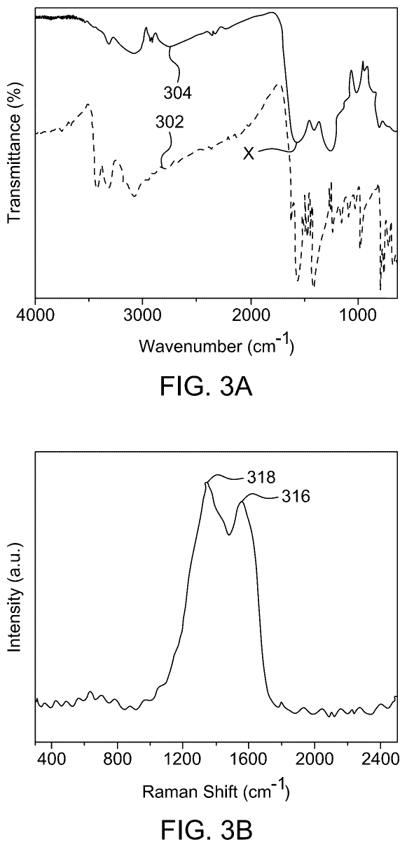

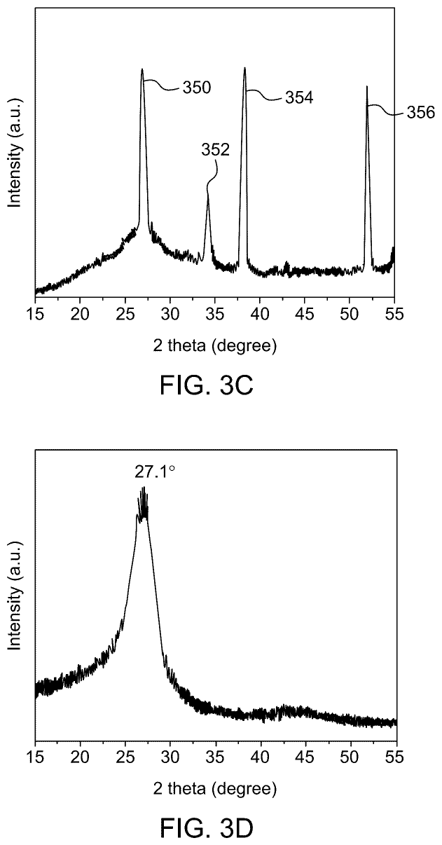

The FT-IR spectrum was obtained to confirm the structure of TAP (302) and g-PTAP (304), as shown in FIG. 3A. Peaks in the region of 1250-1600 cm⁻¹ correspond to C—N heterocyclic. A band ‘X’ around 1570 cm⁻¹ corresponds to C═N stretching of the pyrimidine ring in the g-PTAP. Peaks in the region of 3000-3450 cm⁻¹ correspond to the stretching vibration of —NH, respectively, as in the present region, the coupled doublet bands at around 3420 cm⁻¹ and 3310 cm⁻¹ are associated with the NH-stretching vibrations. A peak at 3070 cm⁻¹ is attributed to the C—H stretching of aromatics. The graphitic nature of the synthesized material was reaffirmed by the Raman spectrum (FIG. 3B). Peaks in the Raman spectrum correspond to the “graphitic (G)” peak (316) and “D” peak (318) of graphite and graphene-like materials situated at around 1560 and 1350 cm⁻¹, respectively. The G peak (316) around 1560 cm⁻¹ is associated with the in-plane C—C/C—N stretching mode of the sp² hybridized carbon network.

FIG. 3C is a graph representing the XRD pattern of the electrode corresponding to the crystallinity of the electrode. The spectrum displayed peaks (350 corresponding to the g-PTAP on the FTO and 352, 354, and 356 corresponding to the FTO). The peaks can be attributed to the FTO substrate. A masking effect of the FTO peak at 27° may not allow differentiation of the g-PTAP peak from the FTO peaks. To confirm the peak position and crystallinity of the g-PTAP, the collected powder was analyzed, and the result was shown in FIG. 3D. A broad and intense peak appeared at a 20 value of 27.1° showing the crystalline nature of the g-PTAP. The peak around 27.1 refers to the (002) plane attributed to interlayer stacking of repeated tris-s-triazine units. The XRD peak of graphitic nitride (g-C₃N₄) was found to be around 27.75 (experimental data), which is similar to the (g-PTAP). However, the g-C₃N₄ had lower carbon content. Generally, an increase in the carbon content leads to a shift in the XRD peak to a lower theta value. Hence, the shift in the XRD peak of the g-PTAP indicates that the g-PTAP has higher carbon content than the g-C₃N₄.

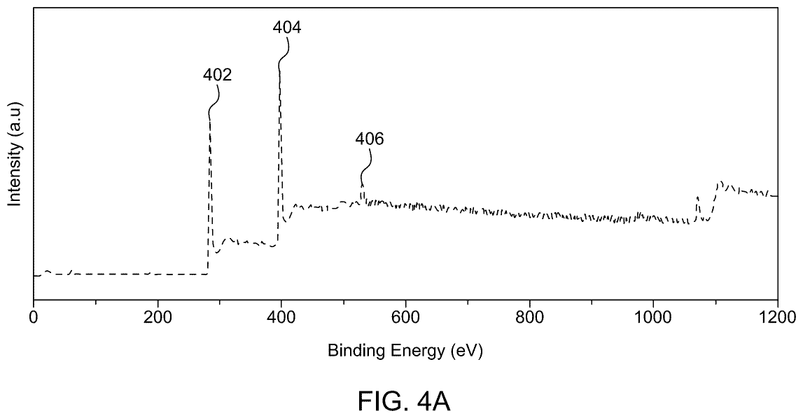

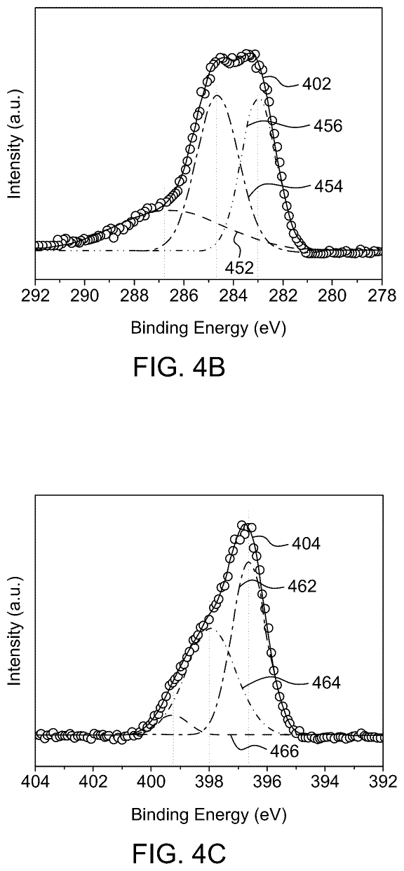

FIG. 4A is a graph representing the XPS spectrum of the g-PTAP, including C1s (402), N1s (404), and O1s (406). High-resolution C1s spectrum (402) and N1s spectrum (404) represent bonding environs in the g-PTAP, and the corresponding spectra were deconvoluted as shown in FIG. 4B and FIG. 4C, respectively. In deconvoluted C1s high-resolution spectrum (402), peaks (452, 454, 456) were found centered at 286.66, 284.63, and 282.99 eV. The peak (452) at 286.66 eV can be attributed to the C═C bond (graphitic sp²), while the peaks (454, 456) at 284.63 and 282.99 can be ascribed to the C—N—C bond and N—C═N bond, respectively. The switching of the peaks towards lesser binding energy can be attributed to the higher carbon content of the TAP precursor compared to melamine. In the case of N₁s XPS spectrum (404), the peak (462) at ˜396.6 eV corresponds to sp²-hybridized N from the heterocycle (C—N═C). Moreover, the peaks (464, 466) at 397.95 and 399.3 eV related to the tertiary N [of N(—C)₃] and uncondensed amino functional groups (NH₂ or NH), respectively.

Moreover, the higher molar ratio of C/N results obtained from the CHN analysis reaffirmed the speculations. The peak of the Ols (406) is attributed to the oxygen and water impurities. The oxygen impurities may be attributed to the oxygen-containing terminal groups, oxides, adsorbed oxygen, or adsorbed water on the g-PTAP surface. Furthermore, a peak around 103 eV can be attributed to Si2p or one or more impurities.

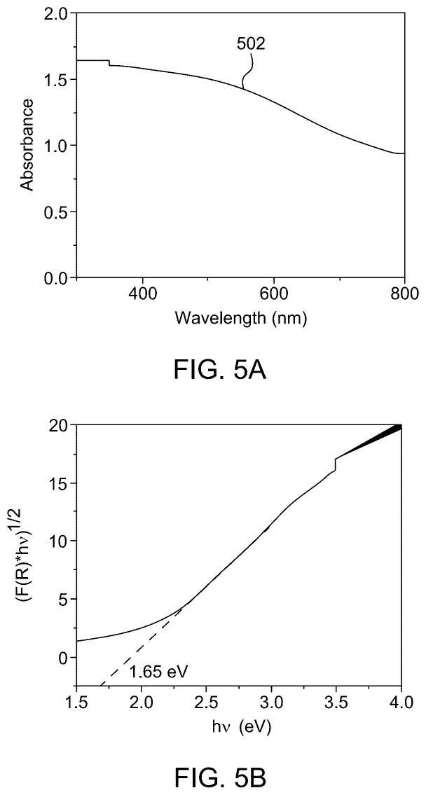

The absorption capacity of the g-PTAP in the visible light region was examined by assessing the UV-Visible spectrum. FIGS. 5A-5B represent the UV-Vis DRS and Tauc plot of the g-PTAP, respectively. The g-PTAP shows an absorption peak (502) in the UV region (π-π* transition in C—C bonds of tri and hepta rings) and the visible region (n-π* transition in C—N bonds of the rings. FIG. 5B shows the band gaps of the g-PTAP, which were found to be ˜1.65 eV.

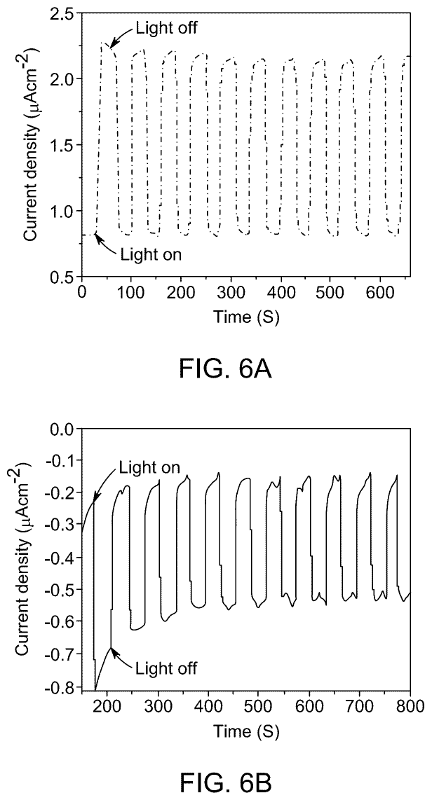

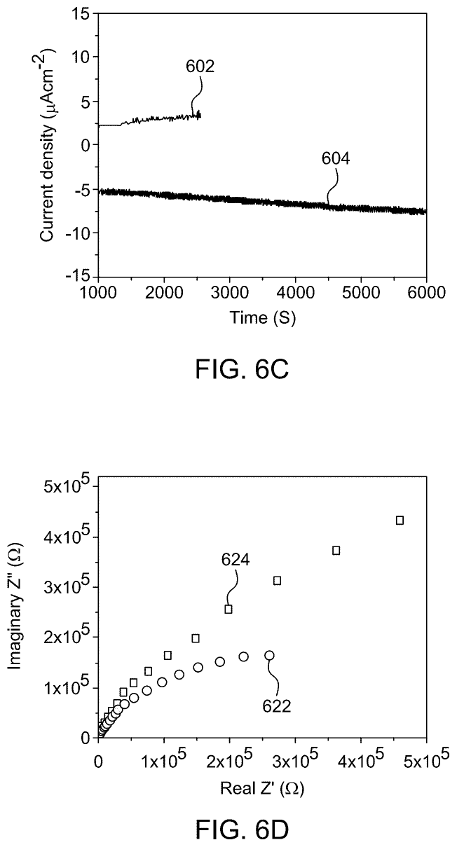

The PEC activity of the g-PTAP was evaluated by employing chronoamperometry and electronic impedance spectroscopy (EIS) electrochemical techniques. FIGS. 6A-6B shows the chronoamperometric response (current density versus time (I-t curve)) obtained under chopped illumination for oxygen evolution reaction (OER) and hydrogen evolution reaction (HER). The chronoamperometric response of the g-PTAP was monitored by assessing a transient photocurrent (under alternating light and dark cycles of 30 seconds(s) interval) at a stabilized potential of 1.0 and −0.2 V vs. SCE for the OER and HER, respectively. FIG. 6A (I-t on/off light cycles of the OER) shows that a prompt generation of a photocurrent in light is apparent and fades instantly as the light is switched off. Similarly, the photocurrent was obtained when the g-PTAP was used as a photocathode during the HER process. During the successive cycles for the OER and HER, such photo-responses were effectively repeated, indicating a periodic generation of excitons. The current density generated at a photoanode in the OER is maintained during the successive cycles. However, a decrease in the current density (generated at the photocathode for the HER during the first 2-3 on/off light cycles) was found and became constant in successive cycles (FIGS. 6A-6B).

Photo-stability of the photoanode or photocathode is essential, and therefore the photo-stability was determined by measuring the I-t response for an extended period, as shown in FIG. 6C. FIG. 6C includes a first trend line 602 corresponding to the photo-stability (1 V) vs. SCE and a second trend line 604 corresponding to the photo-stability (−0.2 V) vs. SCE. The g-PTAP photocathode was more stable (more than 100 minutes with a slight decrease in photocurrent) than the g-PTAP photoanode (stable up to 40.0 minutes). The lower stability of the g-PTAP photoanode may be attributed to the conjugation in the g-PTAP, which restricts the insufficient oxidation ability of the valence holes. Hence, a smaller number of conjugated polymers were utilized for overall water splitting. The EIS was used to understand the interfacial charge transfer resistance at the electrode-electrolyte interface under dark and simulated light. The EIS data were collected at a 10²-10⁵ hertz (Hz) frequency range in Na₂SO₄ electrolyte (0.5 M) at zero potential, and the resulted Nyquist plots are depicted in FIG. 6D. FIG. 6D is a graph showing electronic impedance spectroscopy (EIS) Nyquist plot spectra under illumination (622) and dark conditions (624). Under illumination (622), the charge transfer at the electrode interface with minimized charge recombination is the most significant hurdle in overall water splitting. Further, quick charge transfer with small resistance was observed under the light compared to dark conditions.

The present disclosure provides the g-PTAP nanoflakes on the FTO substrate as an effective photocatalyst for the stoichiometric generation of hydrogen and oxygen by overall water splitting. The g-PTAP has a highest occupied molecular orbital-lowest unoccupied molecular orbital (HOMO-LUMO) energy gap, which is well suited for overall water splitting with the generated photocurrent at the photoanode and photocathode responsible for photo-oxidation and photo-reduction processes. The g-PTAP shows the efficient photo-stability of the photocathode as compared to the photoanode. Therefore, the present disclosure provides new dimensions of using the g-PTAP as a beneficial and efficient complement to other semiconductor materials providing intriguing applications in the PEC not limited to water splitting but other energy applications such as carbon dioxide reduction.

1. (canceled)

2. The method of claim 16, wherein the g-PTAP nanoflakes have a width in a range of 0.5 to 1.5 μm.

3. The method of claim 16, wherein the layer of g-PTAP nanoflakes has a pore size in a range of 1 to 1000 nm.

4. The method of claim 16, wherein the g-PTAP nanoflakes have an interlayer stacking of repeated triazine units.

5. The method of claim 16, wherein the g-PTAP nanoflakes are arranged in an aggregated lamellae form and are slackly packed.

6. The method of claim 16, wherein the g-PTAP nanoflakes have a maximum light absorbance in a visible range.

7. The method of claim 16, wherein the photoelectrode has a band gap at 1.2 to 2.5 electron volts (eV).

8. The method of claim 16, wherein the photoelectrode has a band gap at 1.5 to 2.0 eV.

9. The method of claim 16, wherein the g-PTAP nanoflakes have a broad and intense peak in a range of 2 theta (θ) value 25 to 30° in an X-ray diffraction (XRD) spectrum.

10. The method of claim 16, wherein the g-PTAP nanoflakes have a first main peak in a range of 280 to 290 eV in an X-ray photoelectron spectroscopy (XPS) spectrum, and a second main peak in a range of 394 to 398 eV in the XPS.

11. The method of claim 16, wherein the g-PTAP nanoflakes have peaks at 1250 to 1600 centimeter inverse (cm⁻¹) and 3100 to 3500 cm⁻¹ in a Fourier transform infrared spectrum (FT-IR).

12. The method of claim 16, wherein the g-PTAP nanoflakes have peaks at 1500 to 1590 cm⁻¹ and 3300 to 3450 cm⁻¹ in the FT-IR.

13. (canceled)

14. (canceled)

15. (canceled)

16. A method of photocatalytic water splitting, comprising:
irradiating a photoelectrochemical cell comprising a photoelectrode and water with sunlight to form hydrogen and oxygen,
wherein the photoelectrode comprises:
a fluorine-doped tin oxide (FTO) substrate; and
a layer of graphitic-poly (2,4,6-triaminopyrimidine) (g-PTAP) nanoflakes at least partially covering a surface of the FTO substrate;
wherein the layer of g-PTAP nanoflakes has a sheet like morphology;
wherein the g-PTAP nanoflakes have an average thickness of 5 to 100 nanometer (nm);
wherein the g-PTAP nanoflakes have an average length of 0.2 to 10.0 micrometers (μm); and
wherein the g-PTAP nanoflakes have an average width of 0.1 to 5.0 μm.

17. The method of photocatalytic water splitting of claim 16, which has a repeatability of at least 99%.
